(19) United States
(12) Patent Application Publication
(10) Pub. No.: US 2005/0149969 A1
(43) Pub. Date: Jul. 7, 2005

(54) TV graphical menu interface that provides browseable listing of connected removable media content

(76) Inventors: Vishnu Kumar, Vancouver, WA (US); Mark G. Hanley, Skamania, WA (US)

Correspondence Address: MARGER JOHNSON & MCCOLLOM, P.C. - SHARP, 1030 SW MORRISON STREET, PORTLAND, OR, 97205, US

(21) Appl. No.: 10/971,579

(22) Filed: Oct. 22, 2004

Related U.S. Application Data
(60) Provisional application No. 60/535,049, filed on Jan. 6, 2004.

(51) Int. Cl. H04N 5/445

(52) U.S. Cl. 725/40; 725/37; 725/59; 725/44; 725/45; 725/47; 725/52

(57) ABSTRACT

A method for displaying content on a video display comprising the steps of coupling the video display with an external storage device having content files stored thereon. The content files from the external storage device are then grouped into one or more groups of content files by file type. Each of the groups are associated with a selectable icon, and the grouped content files of a particular type are displayed on the video display responsive to selection of the associated icon.

### CROSS-REFERENCES TO RELATED APPLICATIONS

This application claims the benefit from U.S. Provisional Patent Application No. 60/535,049 filed Jan. 6, 2004 whose contents are incorporated herein for all purposes.

### BACKGROUND OF THE INVENTION

1. Field of the Invention

The invention relates to graphical interfaces, and particularly methods for implementing graphical menu systems for displaying removable media content—including still images, address book entries, web pages, text messages, audio files, and video files—to consumers.

2. Description of the Prior Art

In current televisions, TV menus control basic television features such as video mode, picture brightness, color, audio-specific features such as stereo or mono output signals, channel-controls, parental locks, and other television-centric setups. There are satellite TV systems that provide users with customized channel listings using graphical user interfaces. There currently exists no standard television-driven menu system that supports dynamic recognition and display of content stored on removable devices such as memory cards.

Accordingly, the need remains for an interface that overcomes these drawbacks in the prior art.

### SUMMARY OF THE INVENTION

The current invention describes methods in which TVs with PC card slots or other removable media can display to users the content of the inserted memory device in a graphical, menu-driven manner. The menu-based external media explorer, implemented according to a preferred embodiment of the invention, would group and icon-ize the content of the media based on type and information. This invention extends the TV menu control to recognize and read content of a removable media device such as a memory card. This menu control would not only perform the existing television centric setups, but also would help users explore or browse content from a media outside of the television.

The foregoing and other objects, features and advantages of the invention will become more readily apparent from the following detailed description of a preferred embodiment of the invention that proceeds with reference to the accompanying drawings.

### BRIEF DESCRIPTION OF THE DRAWINGS

FIG. 1 is a block diagram showing a television with removable external storage media implemented to carry out methods according to a preferred embodiment of the invention.

FIG. 2 is a schematic diagram of a remote control used to implement the current invention.

FIG. 3 is a screen shot showing a television function implemented from a first tier graphical menu structure.

FIG. 4 is a screen shot showing a first and second tier menu hierarchy during a browse of an external media browse.

FIG. 5 is a screen shot showing selection of one of the second tier menu items (“Still Images”) from the screen shown in FIG. 3.

FIG. 6 is a screen shot showing a first and third tier menu structure resulting from selection of the second tier menu item from FIG. 4.

FIG. 7 is a screen shot showing a first and third tier menu structure resulting from selection of the audio file menu item from FIG. 4.

### DETAILED DESCRIPTION

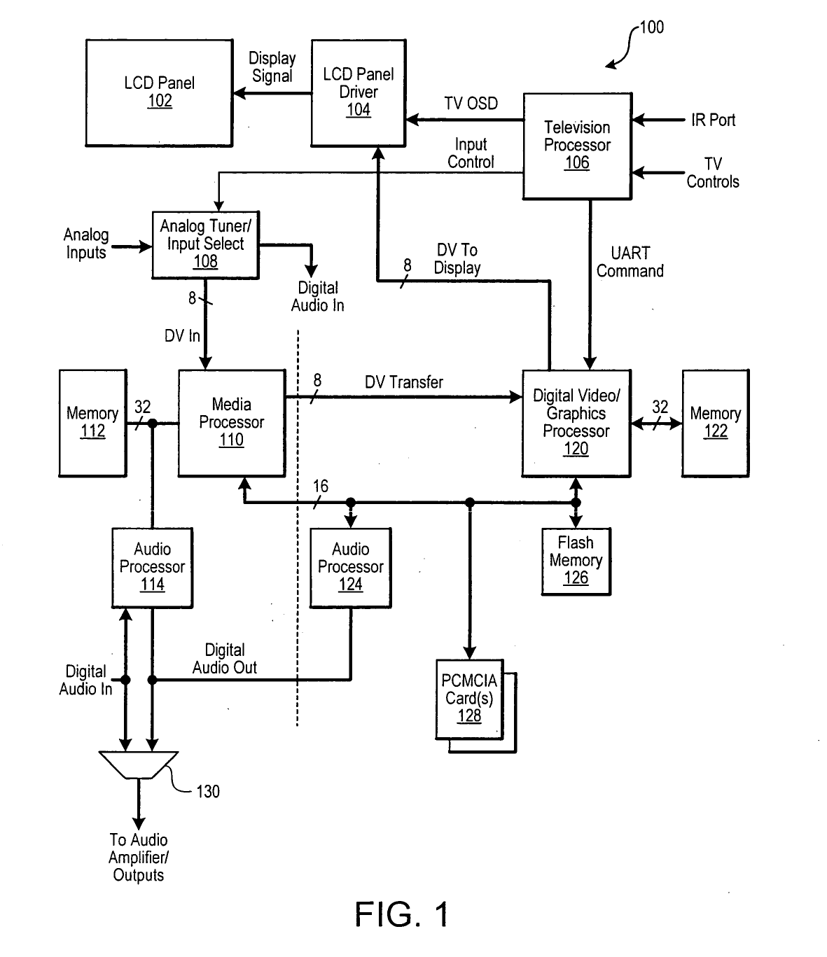

FIG. 1 contains a block diagram for a Liquid Crystal Display (LCD) television capable of operating according to some embodiments of the present invention. Television 100 contains an LCD panel 102 to display visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

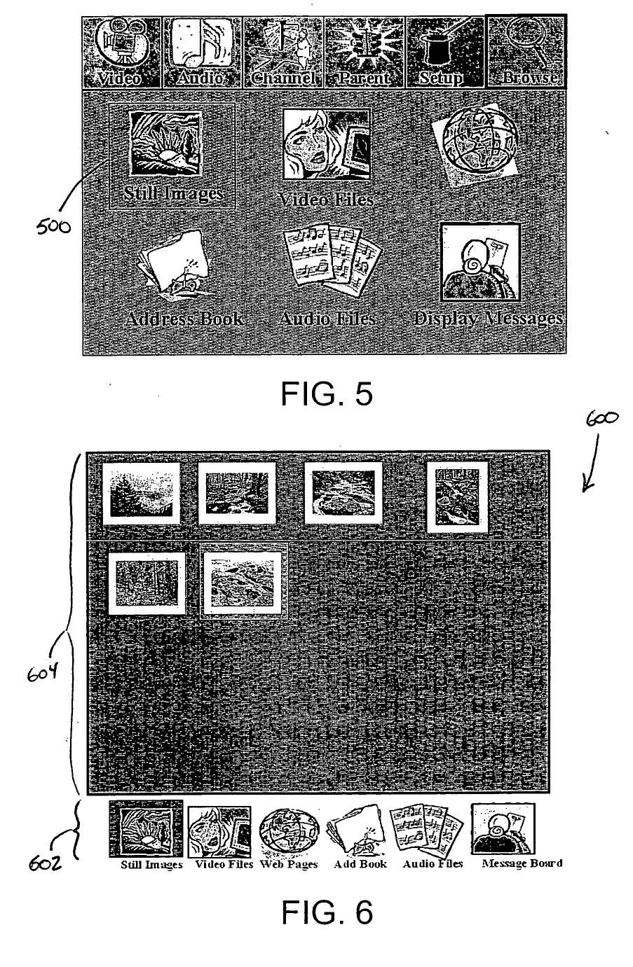

A television processor 106 provides basic control functions and viewer input interfaces for television 100. Television processor 106 receives viewer commands, both from buttons located on the television itself (TV controls) and from a handheld remote control unit (not shown in FIG. 5, but like remote 200) through the IR Port. Based on the viewer commands, television processor 106 controls an analog tuner/input select section 108, and also supplies user inputs to a digital video/graphics processor 120 over a Universal Asynchronous Receiver/Transmitter (UART) command channel. Television processor 106 is also capable of generating basic On-Screen Display (OSD) graphics, e.g., indicating which input is selected, the current audio volume setting, etc. Television processor 106 supplies these OSD graphics as a TV OSD signal to LCD panel driver 104 for overlay on the display signal.

Analog tuner/input select section 108 allows television 100 to switch between various analog (or possibly digital) inputs for both video and audio. Video inputs can include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input select section 108 also selects an audio source, digitizes that source if necessary, and supplies that digitized source as Digital Audio In to an Audio Processor 114 and a multiplexer 130. The audio source can be selected-independent of the current video source-as the audio channel(s) of a currently tuned RF television signal, stereophonic or monophonic audio connected to television 100 by audio jacks corresponding to a video input, or an internal microphone.

Media processor 110 and digital video/graphics processor 120 provide various digital feature capabilities for television 100, as will be explained further in the specific embodiments below. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Media processor 110 supplies digital video, either corresponding to DV In or to a decoded media stream from another source, to digital video/graphics processor 120 over a DV transfer bus.

Media processor 110 performs MPEG (Motion Picture Expert Group) coding and decoding of digital media streams for television 100, as instructed by digital video/graphics processor 120. A 32-bit-wide data bus connects memory 112, e.g., two 16-bit-wide×1M synchronous DRAM devices connected in parallel, to processor 110. An audio processor 114 also connects to this data bus to provide audio coding and decoding for media streams handled by media processor 110.

Digital video/graphics processor 120 coordinates (and/or implements) many of the digital features of television 100. A 32-bit-wide data bus connects memory 122, e.g., two 16-bit-wide×1M synchronous DRAM devices connected in parallel, to processor 120. A 16-bit-wide system bus connects processor 120 to media processor 110, an audio processor 124, flash memory 126, and removable PCMCIA cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to LCD panel driver 104 as is, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input select section 108. The second and third sources are the Digital Audio Outputs of audio processors 114 and 124. These two outputs are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

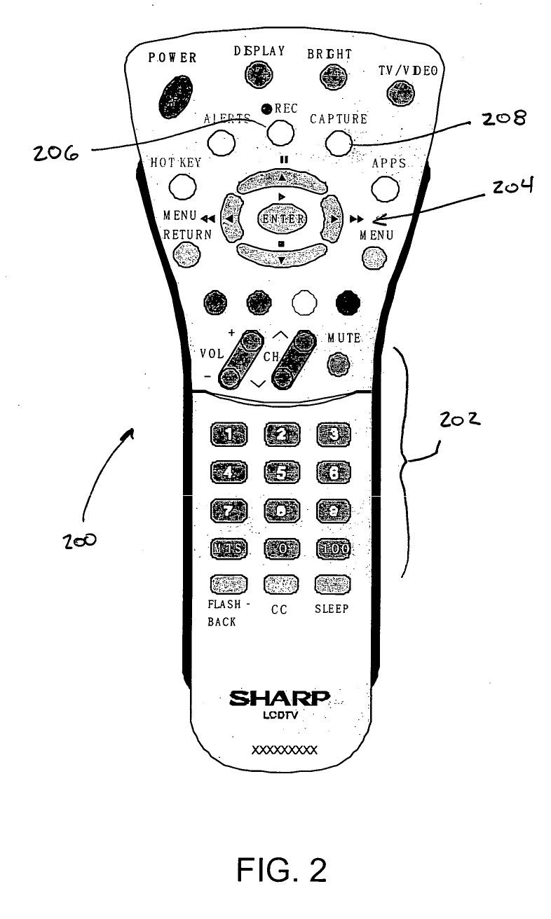

FIG. 2 shows one implementation of a remote control 200 used to implement the invention. The remote control in FIG. 2 includes many local-function buttons 202, examples of which are the number keys 0-9, the volume toggle button, the channel toggle button, and the volume mute button. The remote control further has plurality of browsing or cursor-control keys 204 such as up arrow, down arrow, right arrow, left arrow, and the enter key.

The cursor-control and selection (“enter”) keys are used for the purposes of browsing through the menu structures described in more detail below.

Each key, when depressed, activates a wireless signal (here an infrared signal) to be transmitted from the remote control. Each button activates a separate wireless signal. The television display wireless receiver interpreter compares the signal with a table of functions and matches the signal received with the function requested. The requested function (e.g. raise or lower volume) is then carried out (as by routing more or less power to the speaker amplifiers). Such functions are well known in the art and not described further.

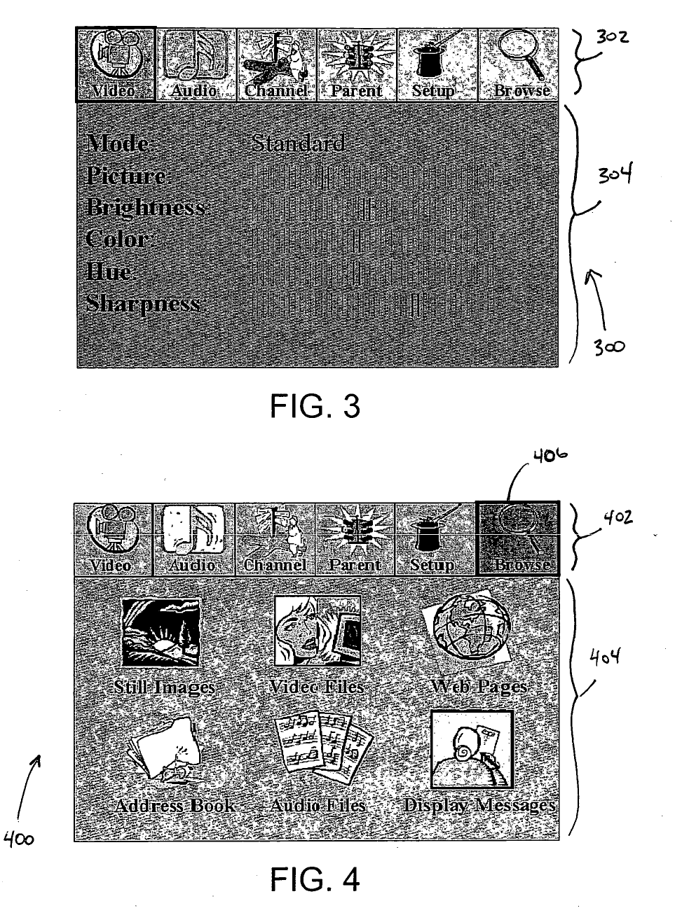

FIG. 3 shows a screen shot at 300 of a television menu system with a browser control implemented according to a preferred construction of the invention. The menu system shown includes a first tier menu hierarchy displayed along a top row 302 of the television monitor, and a second tier menu hierarchy displayed in a lower display field 304 beneath top row. The first tier menu hierarchy, in a preferred implementation, includes the television-specific functions “video”, “audio”, “channel”, “parent”, and “setup” as well as the invention-specific “browse” menu items.

To select a menu item from the top tier menu structure, a user would press the cursor control keys 204 on the remote control 200 to browser over to the desired menu item using the right/left cursor control keys. When the cursor is positioned over the menu item, the menu item is highlighted as the “video” menu item is shown in FIG. 3. Selection of the item may occur automatically, as when the cursor is positioned over the item, or manually, as when the user positions the cursor over the item and selects the “enter” button on remote control 200. FIG. 3 shows in lower screen area 304, with “video” selected in the top tier menu structure, a second tier menu structure including various video adjustment features such as video mode, picture, brightness, color, hue and sharpness. The user may adjust each of these features by again using the cursor control keys and “enter” button. Such adjustments are well known in the art and not described in detail further here.

FIG. 4 shows a screen shot at 400 in which the top tier “browse” menu item 406 in row 402 has been selected to reveal a second tier menu structure in field 404 associated with the browse menu item. The second tier menu structure associated with the “browse” top tier menu item includes, in a preferred embodiment, icons with text directed to each of the following categories “Still Images”, “Video Files”, “Web Pages”, “Address Book”, “Audio Files” and “Display Board”. Each icon on the browser client has a handle to the inserted media storage device, such as PCMCIA cards 128 (FIG. 1), and it can read and display the content to the user in a third tier menu structure as described below. As with the FIG. 3 second tier menu, the media categories represented by the icons shown in field 404 can be selected by moving a cursor over the icon and selecting it as shown in FIG. 5 with the “Still Images” icon 500 highlighted for selection.

Multimedia content may be stored on PCMCIA cards 128, as well as on PCMCIA cards connected to a host computer, or a PCMCIA wired card connected to the computer where such data can be retrieved over a wired connection to the television system 100.

Content may be grouped based on the type (extension) of media present. Example: Images with .jpg extension are grouped together and marked as images as understood by the software. The system would recognize a variety of media content such as .jpeg(images), .asf(video), .html(data) and .mp3(audio). Examples of other grouping schemes based on several different criteria are as follows: (1) time; (2) date created; (3) alphabetical listing by file name; (4) user-indicated preference; (5) most recently accessed; or (6) by user habit. These can be set up as per the user through a set up sequence.

Upon selection of the second tier icon, the content reader client queries the files on the inserted media storage device 128 for the type of files selected by the user. For instance, if as in the FIG. 5 image the “Still Images” icon 500 is selected by the user, the content reader identifies those files on the storage device that are stored in still image format—such as .jpg, .tiff, or some other potential file type. Files of similar media groups are grouped together and the content list is displayed as shown in FIG. 6.

FIG. 6 shows a screen shot at 600 in which the second tier menu items are shown across a bottom row 602 and the third tier media item list is shown in upper display field 604. The list is the present example shown is comprised of thumbnail images of each of the still images retrieved from the inserted media storage device 128. Initially, images (thumbnail part only) are retrieved from memory to display thumbnail of required images on the drive/network. If a user selects to view them on a regular size (slideshow), they are then read from the drive real time and decoded. A Jpeg decoder software residing on graphic processor [FIG. 1] 120 or Media processor 110 to decode the thumbnail from the image files. The preview engine, onscreen display and video interface section of the 120 and 110 processors scales and display the images to the screen. The user chooses to view the images stored on the media device 128 by moving the cursor over to a picture and selecting it. The image viewer client then reads and displays the images for the user. These images could then be enlarged or be used for various other application dependent purposes such as screen savers, printing, etc.

The image viewer client (software browser) displays decoded images on the TV 102. Client viewer software is an application with a user interface that allows a viewer to control his media while viewing; that is, select slideshow or music with virtual buttons for show, album, pause, resume, and stop which operate on 120 and 110 processors [FIG. 1].

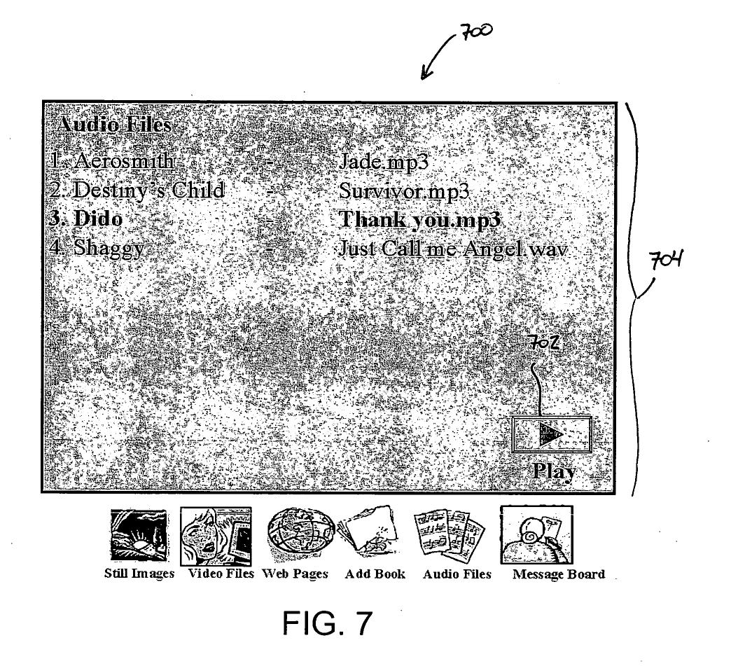

FIG. 7 shows at 700 another example of a third tier menu structure list, this time from the “Audio Files” second tier menu item. Instead of thumbnail images, the list is textual in nature. A user would browse down to a desired audio file and select it for play. The user could have audio files on a memory card which he may want to play on his television. The television menu explorer would show the user all the audio files that may be present on the media card. The user could select any from the selection and play it through the television speakers. Play can occur automatically upon selection, or can occur manually as by browsing to and selecting the play button 702 within the upper display field 704.

The television system of the present invention includes various application software operating thereon. A media interpreter is software programmed to recognize media extensions and types from files stored in memory systems operative within (such as cards 128) the television system 100, or connected to such a system as over a network connection. These media types can be proprietary or known such as .jpeg, .asf, .mp3. Media recognized by the interpreter allows it to be played on the TV. Accordingly, decoders for the various media types exist on the system that understand and can play these media types.

A new media discovery client operates on television system 100 when the system is connected to a storage device (card or PC over network) and new media is added. The client recognizes this new media insertion and updates its listing. Example of new media being added to the card can be image captured using the software residing on the TV with a video capture program residing on the TV. New media can be added to the networked PC by using its drives (e.g. PCMCIA).

A content reader client, operative on the television system a text and image parser. As content can be obtained from a variety of resources, content needs to a read (parsed) and re-displayed in a reasonable format and screen resolution to make it easier for the viewer to browse through the data. The content reader may be compatible with a variety of source such as html, doc, pdf, email etc.

Once the media is discovered, interpreted and read into right screen format, the system use the preview engine to effect content display. On screen display (OSD) of the content is operated by processor (120/110 FIG. 1) to display the content properly on the system 100.

Other media clients operative on the television system 100 include an image viewer client, an audio player, a video player, an address book content display client, and an email or web page display client.

The image viewer client operates as a photo browser for the system. This is a user application which allows user to select slideshow, select music to go with slide show, select album, pause, play, stop and resume. User interfaces may vary.

The audio player client operates as an audio browser for the system. This is a user application that allows the user to select music, view/select from a playlist of content and read about singer and/or album, group. The player allows a user to pause, play, stop, resume, fast-forward, rewind responsive to user actions on the remote control 200.

The video player operates as a video browser for the system. This user application allows a user to select video, view a playlist, pause, resume, jump to live, Fast-forward, rewind, stop and play responsive to user actions on the remote control 200.

The address book content display client operates as an address content book browser. The application interface allows a user to add, edit, remove, and view content stored either on the PC card or over the network. This Address book may interface and be compatible with known address books such as Outlook using means known in the art.

The email/webpage display client operates as an email and webpage browser. The application allows users to view and write emails and display webpages. Content for these shall be obtained from a remotely connected PC. Operation of the email and web browser client can be effected by using a keyboard interface to the TV and/or remote control with qwerty (keys) associated with the number pad.

Some applications may be associated with certain pre-set buttons on the remote control 200. Two examples of these are record button 206 and the still image capture button 208. Pressing the record button 206 causes the video signal from media processor 110, such as a television station to which the television system 100 is currently tuned using tuner 108, to be recorded on PCMCIA cards 128 for storage and later playback. This is useful for immediate recording where the viewer is watching television, for instance, and an important moment appears only briefly on the screen. Ordinarily it would require several steps to cause recording, for which the delay may cause the viewer to miss the event. One button recording is thus a useful feature of the invention.

Pressing the capture button 208 causes the current video image from media processor to be captured on PCMCIA cards 128 for storage and later playback in a manner similar to the video images described above. The captured still images would be stored in an appropriate file format, such as .jpg, and ordered within certain media categories for later playback.

The present implementation loads a JPEG Encoder program onto the MP processor 110 and encodes a JPEG of the current live TV. This means if we are already time shifted, we will end up losing the time-shift and jumping to Live TV to capture the image (the image will be from the live TV.)

An alternate potential embodiment would freeze the frame and save it to a buffer, load the JPEG encoder onto the DVGP processor 120 while continuing to encode MPGE4 on the MP processor 110. Once encoding was complete the MPEG4 decoder could be loaded back onto the processor 120 and decoding of the MPEG4 stream would resume from the frozen frame.

Data is captured using still image (.jpg) or moving image (MPEG4) formats on storage medium such as cards 128 and grouped for selection and playback using the user interface described above.

Having described and illustrated the principles of the invention in a preferred embodiment thereof, it should be apparent that the invention could be modified in arrangement and detail without departing from such principles. We claim all modifications and variation coming within the spirit and scope of the following claims.

1. A media player comprising:
a television tuner;
a video display;
an audio play unit;
a connector for coupling an external storage device to the media player;
a microprocessor coupled to the tuner, display, audio play unit, and external media connector;
internal memory having stored therein menu displays for television features and media content features; and
a menu control system operable on the microprocessor and including:
means for identifying content stored on the external storage device as belonging to one of a plurality of preset content groups;
means for displaying on the video display icons representative of the present content groups; and
means for displaying on the video display a content list generated from the external storage device responsive to selection by a user of a particular one of the icons.

2. The system of claim 1, wherein the content groups include video files, still image files, and audio files.

3. The system of claim 2, further including the content groups web pages, address book and display messages.

4. The system of claim 1, wherein the menu control system includes a top tier function group including television functions and an external media browse function.

5. The system of claim 4, wherein the television functions include video, audio, channel, parent and setup.

6. The system of claim 4, wherein the menu control system includes a second tier function group, responsive to selection of the external media browse function, including content types still images, video files and audio files.

7. The system of claim 6, wherein the second level function group responsive to selection of the external media browse function further includes web pages, address book, and display messages.

8. The system of claim 6, wherein the menu control system includes a third tier function group, responsive to selection of a one of the content types of the second level function group, displaying information about files identified with the third tier function group.

9. The system of claim 8, wherein the information includes thumbnail images of the files.

10. The system of claim 8, wherein the information includes textual lists of the files.

11. A method for displaying content on a video display comprising the steps of:
coupling the video display with an external storage device having content files stored thereon;
grouping the content files from the external storage device into one or more groups of content files by file type;
associating each of the groups with a selectable icon; and
displaying the grouped content files for selection responsive to selection of the associated icon.

12. The method of claim 11, wherein the groups include still images, video files, and audio files.

13. The method of claim 12, wherein the step of displaying the grouped content files includes the step of displaying on the video display thumbnail images of still files stored on the external storage device.
